(19) United States
(12) Patent Application Publication
(10) Pub. No.: US 2009/0052042 A1
(43) Pub. Date: Feb. 26, 2009

(54) LIGHT TUNNEL STRUCTURE AND MANUFACTURING METHOD THEREOF

(75) Inventor: Ren-Meng LIAO, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/055,628

(22) Filed: Mar. 26, 2008

(30) Foreign Application Priority Data
Aug. 20, 2007 (TW) 96130654

(51) Int. Cl. G02B 27/00; B23Q 7/00

(52) U.S. Cl. 359/596; 29/559

(57) ABSTRACT

A light tunnel structure includes a plurality of reflecting plates and an impervious layer. The reflecting plates are connected to each other to form a light tunnel. An end surface of each reflecting plate and an end surface of the adjacent reflecting plate of the two adjacent reflecting plates form an joint. The impervious layer is disposed at the joints formed by the adjacent reflecting plates. A method for manufacturing a light tunnel structure is disclosed.

### BACKGROUND OF THE INVENTION

1. Field of the Invention

The invention relates to a light tunnel structure and a manufacturing method thereof, and more particularly to a light tunnel structure characterized by humidity and water resistance and a manufacturing method thereof.

2. Description of the Related Art

A light tunnel, an optical component applicable to an optical engine of an optical projection system, is utilized to uniformly and precisely project light passing therethrough to an effective area of a light source modulating device to prevent uninformed brightness at a particular light path of the light engine. To achieve high quality of the optical projection system, brightness and power for light sources must be increased, therefore, increasing temperature of light beams emitted from the light sources. Thus, it is understood that bonding strength and heat resistance are crucial factors for designing the light tunnel applied in the optical projection system.

In FIGS. 1A and 1B, a conventional light tunnel structure 1 is a hollow structure formed by four stripped mirrors, i.e., a top mirror 11, a bottom mirror 12, a right mirror 13 and a left mirror 14. Optical films with high reflectivity are applied to the inner wall of the mirrors 11, 12, 13 and 14. By abutting the top mirror 11 and the bottom mirror 12 against the right mirror 13 and the left mirror 14, a rectangular passage is formed therebetween. UV glue 15 or UV-epoxy glue, a mixture of UV glue and epoxy, is partially applied at the joints of the connected mirrors 11, 12, 13 and 14 for attaining a temporal connection therebetween, and a ceramic glue 16 is then applied at the joints of the connected mirrors 11, 12, 13 and 14 for attaining a permanent connection therebetween, thus, to form the light tunnel structure 1.

Nowadays, due to the high brightness and high power of light sources and the demand for high quality of present projectors and back-projecting televisions, inner temperatures thereof have relatively increased. Although UV glue 15 and ceramic glue 16 can facilitate the assembly of the light tunnel structure 1, the light tunnel structure 1 might collapse due to the glues, with individual heat expansion coefficient, dissolving under a high temperature environment or precision errors might deteriorate optical quality of the light tunnel structure 1. Furthermore, the surface of the glues might be hygroscopic under a poor water-resistant or a high humid environment, i.e., water permeates the light tunnel structure 1 to deteriorate the material and enters the interior thereof to damage the light tunnel regions.

### BRIEF SUMMARY OF THE INVENTION

To solve the aforementioned problems, the invention provides a light tunnel structure and a manufacturing method thereof for increasing resistance to high temperature and water, thus, allowing the light tunnel structure to normally function at high temperatures and in a humid environment. The invention provides a light tunnel structure including a plurality of reflecting plates and an impervious layer. The reflecting plates are connected to each other to form a light tunnel. The two adjacent reflecting plates form a joint therebetween. The impervious layer is disposed at the joints of the reflecting plates.

To attain the above objectives, the invention further provides a method for manufacturing a light tunnel structure. The method includes the following steps: providing a jig; providing a plurality of reflecting plates to abut against the jig; applying an impervious layer at a joint of the reflecting plates; applying a bonding layer on the impervious layer; and removing the jig to form a light tunnel structure.

As aforementioned above, the invention provides the impervious layer disposed at the joint of the adjacent reflecting plates to prevent the liquidized thermal-setting adhesive from dissolving under high humidity and temperatures from entering and damaging the light tunnel structure. Because the liquidized thermal-setting adhesive is prevented from dissolving, thus improving optical efficiency, reliability of the light tunnel structure is increased in comparison with conventional methods.

### BRIEF DESCRIPTION OF THE DRAWINGS

The present invention will become more fully understood by from the subsequent detailed description given here below and the accompanying drawings which are given by way of illustration only, and thus are not limitative of the present invention, and wherein:

FIG. 1A is a schematic view of a conventional light tunnel structure;

FIG. 1B is a cross-sectional view of the light tunnel along line A-A of FIG. 1A;

FIG. 2A is a schematic view of a light tunnel structure of a first embodiment of the invention;

FIG. 2B is a cross-sectional view of the light tunnel along line B-B of FIG. 2A;

FIGS. 3A, 3B 3C and 3D are schematic views showing the processes of forming a light tunnel structure according to the invention;

FIG. 4A is a schematic view of a light tunnel structure of a second embodiment of the invention;

FIG. 4B is a cross-sectional view of the light tunnel structure along line D-D of FIG. 4A.

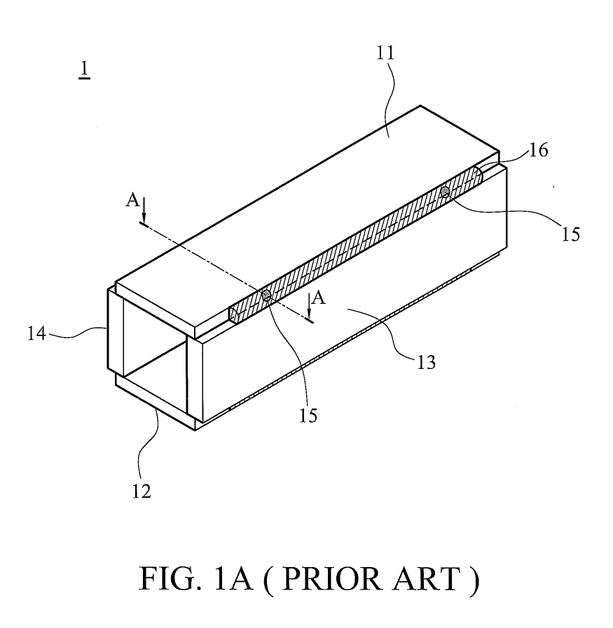

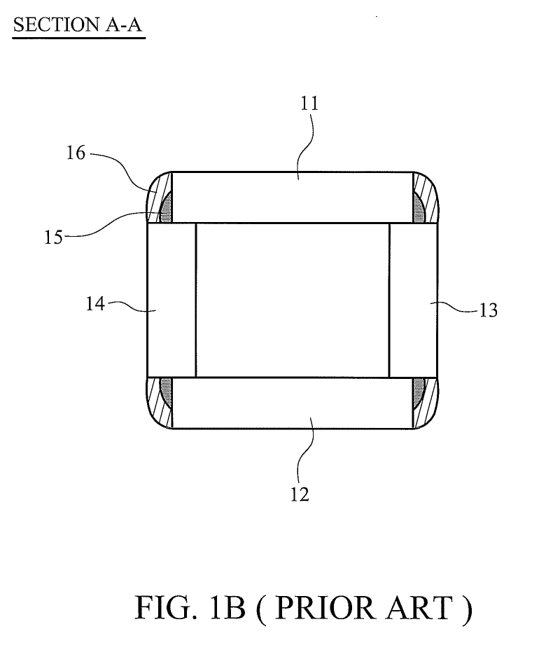

### DETAILED DESCRIPTION OF THE INVENTION

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

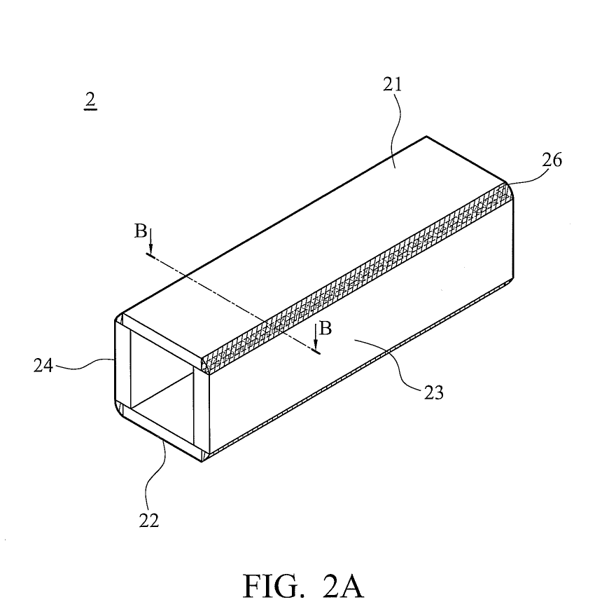

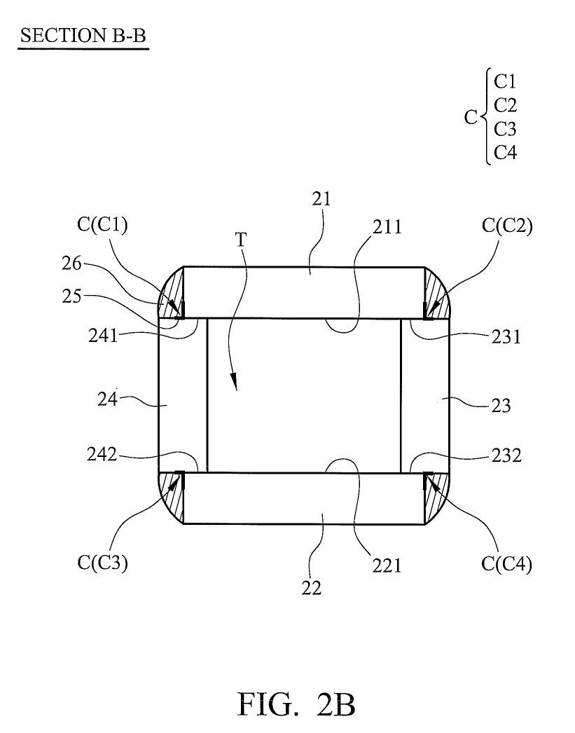

Referring to FIGS. 2A and 2B, the light tunnel structure 2 is applicable to a light integration rod or a light guide tube of a projecting device (not shown in the drawings). The light tunnel structure 2 includes a plurality of reflecting plates, an impervious layer 25 and a bonding layer 26. In this embodiment, the amount of the reflecting plates is four, defined as a first reflecting plate 21, a second reflecting plate 22, a third reflecting plate 23 and a fourth reflecting plate 24, respectively, and each of the reflecting plate has a polygonal shape such as rectangular shape. In other embodiment, the reflecting plate can be formed as trapezoidal.

The first and second reflecting plates 21, 22 have the same shape and are faced to each other, and the third and fourth reflecting plates 23, 24 have the same shape and are faced to each other. End surfaces 231 of the third reflecting plate 23 and end surface 241 of the fourth reflecting plate 24 are abutted against the end surface 211 of the first reflecting plate 21, and end face 232 of the third reflecting plate 23 and end face 242 of the fourth reflecting plate 24 are abutted against the end surface 221 of the second reflecting plate 22. A joint C is formed by two of the adjacent reflecting plates so that the four reflecting plates are connected to form a light tunnel T. That is, a first joint C1 is formed between the end surfaces 211 and 241, a second joint C2 is formed between the end surfaces 211 and 231, a third joint C3 is formed between the end surfaces 221 and 242, and a fourth joint C4 is formed between the end surfaces 221 and 232. One side of each of the reflecting plates 21, 22, 23 and 24 utilized to form the light tunnel T includes a reflecting layer (not shown in the drawings). The reflecting layer made of metallic, alloy or dielectric material is utilized to reflect light passing through the light tunnel T. The impervious layer 25 and the bonding layer 26 are disposed at the joints C. The impervious layer 25 is applied at the joints C prior to the applying of the bonding layer 26 at the joints C, i.e., the bonding layer 26 is disposed on the impervious layer 25. The bonding layer 26 is formed by filling an adhesive. The adhesive is a thermal-setting adhesive such as ceramic glue, Al₂O₃, organic polymer, or can be other equivalent adhesives. In this embodiment, the impervious layer 25 is made of silicon-containing material, silicon or heat proof material.

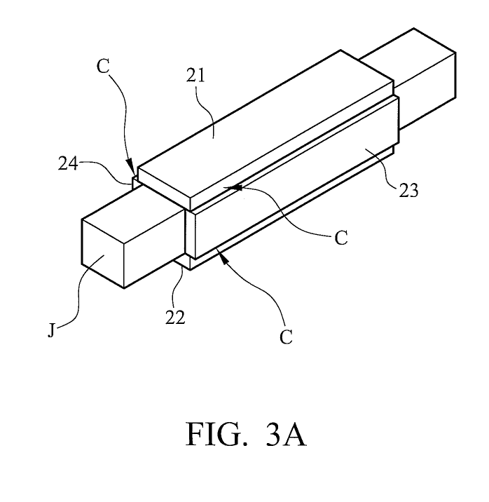

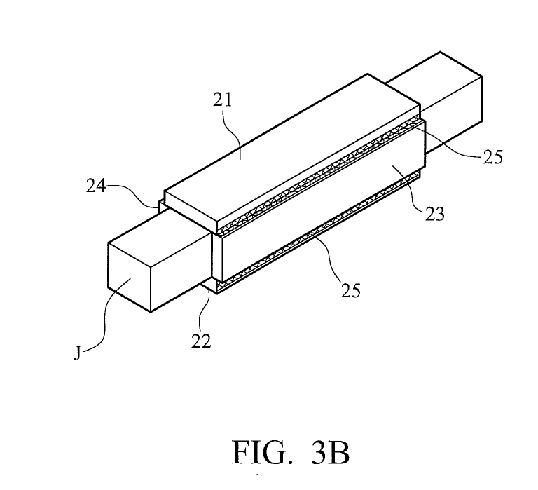

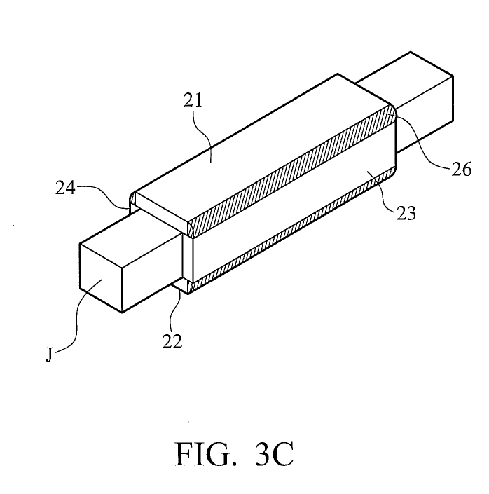

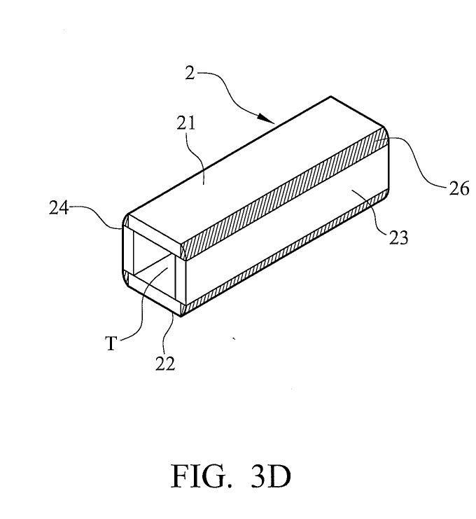

Referring to FIGS. 3A to 3D, a method for manufacturing a light tunnel structure 2 includes the following steps. First, a jig J is provided to define region of the light tunnel T. The reflecting plates 21, 22, 23 and 24 are provided to closely abut against the jig J via pressure consolidation or vacuum absorption. In FIG. 3A, the joint C is formed between the two end surfaces of the two adjacent reflecting plates. In FIG. 3B, the impervious layer 25 is applied at each of the joints C. In FIG. 3C, the adhesive is applied on the applied impervious layer 25 at each of the joints C to form the bonding layer 26. The filled bonding layer 26 is solidified by thermal setting. In FIG. 3D, after removing the jig J, the formation of the light tunnel structure 2 with the light tunnel T is completed. That is, the impervious layer 25 has a setting zone, and the bonding layer 26 has a filling zone which is smaller than the setting zone of the impervious layer 25. In other embodiments, the filling zone of the bonding layer 26 can be equal to the setting zone of the impervious layer 25.

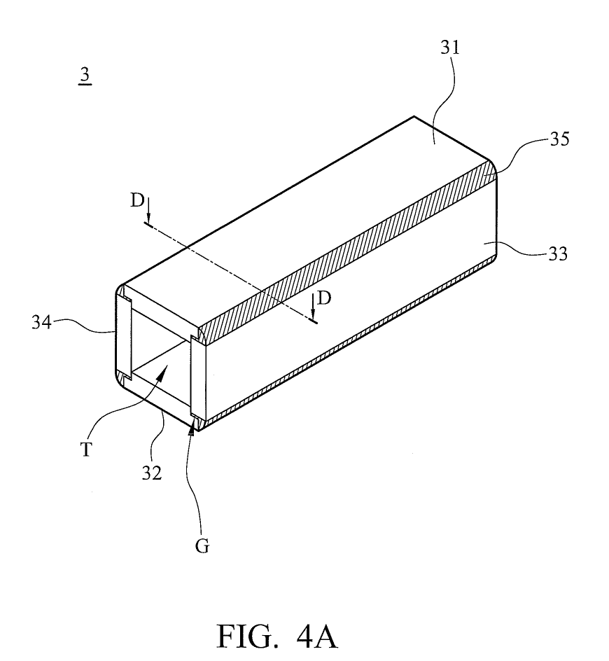

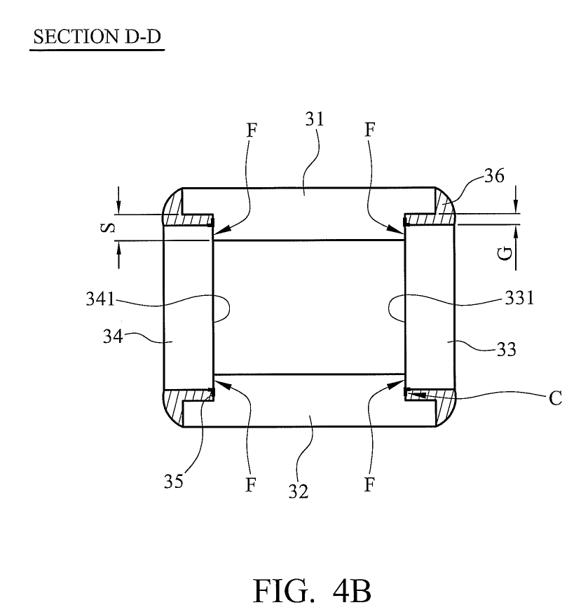

FIG. 4A is a perspective view of a light tunnel structure 3 of a second embodiment, and FIG. 4B is a cross-sectional view of the light tunnel structure 3 along line D-D of FIG. 4A. In FIGS. 4A and 4B, a light tunnel structure 3 includes a plurality of reflecting plates, an impervious layer 35 and a bonding layer 36. In this embodiment, the amount of the reflecting plates is four, and the light tunnel structure 3 is defined by the four reflecting plates. The first and second reflecting plates 31, 32 are one set of corresponding reflecting plates, and the third and fourth reflecting plates 33, 34 are another set of corresponding reflecting plates. The set of the corresponding reflecting plates 31 and 32 have stepped edges with thickness S, and thus, the longitudinal cross-sections of the first and second reflecting plates 31, 32 are formed with protruded profiles, respectively. That is, the cross-sections of the first and second reflecting plates 31, 32 are different from those of the third and fourth reflecting plates 33, 34.

In FIG. 4B, when the set of the first and second reflecting plates 31, 32 and the set of the third and fourth reflecting plates 33, 34 are assembled, the end surfaces 341 and 342 of the third and fourth reflecting plates 33, 34 are abutted against the contact surfaces F of the thickness S of the first and second reflecting plates 31, 32 to form gaps G at the joints C therebetween. After applying the impervious layer 35 at the joints C of the reflecting plates 31-34, the bonding layer 36 is filled in the gaps G at the joints C. Note that the mechanical property of the assembled light tunnel structure 3 can be improved by increasing the bonding area of the bonding layer 36 filled in the gaps G at the joints C. The jig, as shown in FIG. 3C, can assist the assembling of the adjacent reflecting plates 31, 32, 33 and 34 to stabilize the controlling of vertical degree thereof. Further, the gaps G function as allowance areas for adjusting vertical degree of assembling the reflecting plates 31, 32, 33 and 34, thereby eliminating dimension errors caused by the light tunnel structure.

Based on the described features, it is understood that the light tunnel structure and manufacturing method thereof of the embodiments provide the impervious layer disposed at the joint of the adjacent reflecting plates to prevent the ceramic glue from dissolving under high temperatures or water vapor during high-temperature and high humid environments from entering and damaging the light tunnel. Thus, reliability of the light tunnel structure is relatively increased in comparison with cited conventional methods.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light tunnel structure, comprising:
a plurality of reflecting plates connected with each other to form a light tunnel; and
an impervious layer disposed at joints of the reflecting plates.

2. The light tunnel structure as claimed in claim 1, wherein the reflecting plates comprise a first reflecting plate, a second reflecting plate, a third reflecting plate and a fourth reflecting plate, and the first and second reflecting plates have the same shape and are faced to each other.

3. The light tunnel structure as claimed in claim 2, wherein the first and second reflecting plates have stepped edges.

4. The light tunnel structure as claimed in claim 3, wherein the cross-sections of the first and second reflecting plates are different from those of the third and fourth reflecting plates.

5. The light tunnel structure as claimed in claim 4, wherein the cross-section of the first reflecting plate has a protruded profile.

6. The light tunnel structure as claimed in claim 1, wherein the impervious layer is made of silicon-containing material, silicone or heat proof material.

7. The light tunnel structure as claimed in claim 1, further comprising a bonding layer disposed on the impervious layer.

8. The light tunnel structure as claimed in claim 7, wherein the bonding layer is formed by filling an adhesive, thermal-setting adhesive, ceramic glue, Al₂O₃, or organic polymer.

9. The light tunnel structure as claimed in claim 1, further comprising a reflecting layer formed on one surface of each of the reflecting plate for reflecting light.

10. The light tunnel structure as claimed in claim 9, wherein the reflecting layer comprises metallic, alloy or dielectric material.

11. A method for manufacturing a light tunnel structure, comprising the steps of:
providing a jig;
providing a plurality of reflecting plates to abut against the jig;
applying an impervious layer at a joint of the reflecting plates;
applying a bonding layer on the impervious layer; and
removing the jig to form a light tunnel structure.

12. The method as claimed in claim 11, wherein the reflecting plates comprise a first reflecting plate, a second reflecting plate, a third reflecting plate and a fourth reflecting plate, and the first and second reflecting plates have the same shape and are faced to each other.

13. The method as claimed in claim 12, wherein the first and second reflecting plates have stepped edges.

14. The method as claimed in claim 13, wherein the cross-sections of the first and second reflecting plates are different from those of the third and fourth reflecting plates.

15. The method as claimed in claim 14, wherein the cross-sections of the first reflecting plate has a protruded profile.

16. The method as claimed in claim 11, wherein the shape and size of the jig corresponds to that of the light tunnel structure.

17. The method as claimed in claim 11, wherein the reflecting plates are abutted against the jig via pressure consolidation or vacuum absorption.

18. The method as claimed in claim 11 further comprising a step of solidifying the bonding layer after the step of applying the bonding layer.

19. The method as claimed in claim 18, wherein the step of solidifying the bonding layer comprises thermal setting.

20. The method as claimed in claim 11, wherein the impervious layer is made of silicon-containing material, and the bonding layer comprises an adhesive, thermal-setting adhesive, ceramic glue, Al₂O₃, or organic polymer.
